(19) United States
(12) Patent Application Publication
(10) Pub. No.: US 2010/0108695 A1
(43) Pub. Date: May 6, 2010

(54) AIR-POCKET INSULATED DISPOSABLE PLASTIC CUP

(75) Inventors: Qiuchen Peter Zhang, Alpharetta, GA (US); Darryl J. Dawson, SR., Stockbridge, GA (US)

Correspondence Address: THE COCA-COLA COMPANY;PATENT & TECHNOLOGY DEPT--NAT 19, P. O. BOX 1734, ATLANTA, GA, 30301, US

(73) Assignee: The Coca-Cola Company, Atlanta, GA (US)

(21) Appl. No.: 12/612,136

(22) Filed: Nov. 4, 2009

Related U.S. Application Data
(60) Provisional application No. 61/111,096, filed on Nov. 4, 2008.

(51) Int. Cl. B65D 81/38; B29C 65/08; B29C 65/00

(52) U.S. Cl. 220/592.26; 156/73.1; 156/60

(57) ABSTRACT

An air pocket insulated double-walled disposable plastic container having an inner sheet and an outer sheet. The inner sheet is formed having inwardly protruding indentations that create a plurality of uniformly spaced air pockets when the inner sheet is attached to an inner surface of the outer sheet in a manner whereby the indentation contacts the inner surface of the outer sheet 104. The air pockets act as insulating layer. The container may be formed in any suitable shape that includes an opening at the top, an interior space for containing food or beverages, and a base enclosing the bottom.

The present invention generally relates to disposable plastic containers, and more particularly to a thermally insulated disposable plastic containers. More specifically, the present invention relates to air pocket thermally insulated double-walled disposable plastic containers.

### BACKGROUND OF THE INVENTION

The production and use of thermally insulated disposable containers, such as cups, are well known and highly desirable. Thermally insulated disposable cups are generally useful for both hot and cold beverages. They are designed to maintain the beverage temperature by preventing undesirable heat transfer between the beverage, the atmosphere, and cup holder's hand. Currently available thermally insulated disposable cups are generally made from paper, polymeric materials or combinations thereof.

Paper-based materials are generally favored for disposable cups, because of low cost and high volume production capability. However, paper-based materials generally do not have good liquid barrier properties. Disposable cups made from such paper-based materials, have a tendency to decompose due to liquid penetration into the paper material, which can cause the cup to lose its structural integrity and become soggy or leak. Furthermore, cups made from paper-based materials generally do not provide adequate thermal insulation.

U.S. Pat. No. 5,145,107 to Silver et al. teaches a double-walled thermal insulated disposable paper cup having an inner wall connected to an outer wall at the lip and at the base of the cup. The walls have different tapers which define an air pocket between the two walls. The air pocket is meant to provide thermal insulation. However, as with currently available paper-based disposable cups, structural integrity remains a problem.

Polymeric materials, such as polypropylene, polyethylene terephthalate (PET) based polyesters and polystyrenes have been widely used as container materials for disposable containers because of their improved mechanical and barrier properties. Disposable articles such as plastic drinking cups and lids are generally made of polystyrene or polystyrene blends. However, containers made from such polymeric materials do not provide adequate thermal insulation. The lack of good thermal insulation properties often results in rapid heat loss for beverages; or cups that are too hot or cold to hold. Accordingly, it would be desirable to provide a thermally insulated disposable plastic container.

### SUMMARY OF THE INVENTION

The present invention relates to an air pocket insulated double-walled disposable plastic container for containing food or beverages. Air pocket insulated double-walled disposable plastic containers in accordance with the invention provide recyclability, enhanced barrier properties and excellent thermal insulation. In addition a container in accordance with the invention can be transparent or translucent. Accordingly, a method for making the air-pocket insulated disposable double-walled plastic container is also provided herein. The method of manufacture used to make the air pocket insulated double-walled disposable plastic container is cost effective and energy efficient.

In an embodiment of the invention, the air-pocket insulated double-walled disposable plastic container includes a container body having an inside sheet having protrusions formed thereon fixedly connected to an outside sheet in a manner which forms air pockets between the first and second sheet. The method of making an air pocket insulated disposable double-walled container includes the steps of joining a first sheet and a second sheet to form a double-walled sheet. The first sheet includes an indented pattern and the second sheet is a smooth sheet having no indentations. The first sheet and the second sheet are joined by contacting the indented face of the first sheet to the second sheet thereby creating air pockets between the two sheets in the double-walled sheet. The double-walled sheet is then used in a molding process to form an air pocket insulated double-walled disposable plastic container.

### BRIEF DESCRIPTION OF THE DRAWINGS

FIG. 1 is a cross-sectional view of one embodiment of a container of the invention.

FIG. 1A is a cut-out view of the container of FIG. 1

FIG. 2 is a cross-sectional view of another embodiment of the invention.

FIG. 3 shows a process of making the container of the invention.

### DESCRIPTION OF THE ILLUSTRATED EMBODIMENTS

The present invention provides am air pocket thermally insulated double-walled disposable plastic container having excellent insulation properties, recyclability, and optionally transparency. As used herein the term “plastic” refers to a wide range of synthetic or semi-synthetic polymerization products, composed of organic condensation or addition polymers and may contain other substances, including bio materials and recycled content, to improve performance or reduce costs. “Disposable” as used herein is meant to describe articles that are most often discarded after one use. “Double-walled” as used herein refers to a structure that includes at least two sheets or layers of polymeric material. The term “insulated or insulating” as used here in refers generally to the prevention of reduction of heat transfer from conducting bodies. The term ‘air pocket insulated double-walled disposable plastic container’ may alternatively be referred to as ‘container’ for convenience.

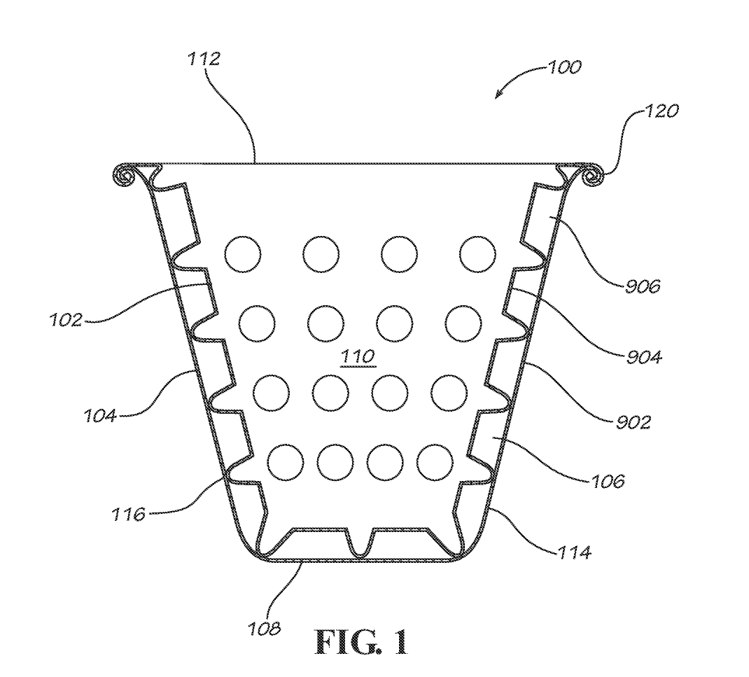

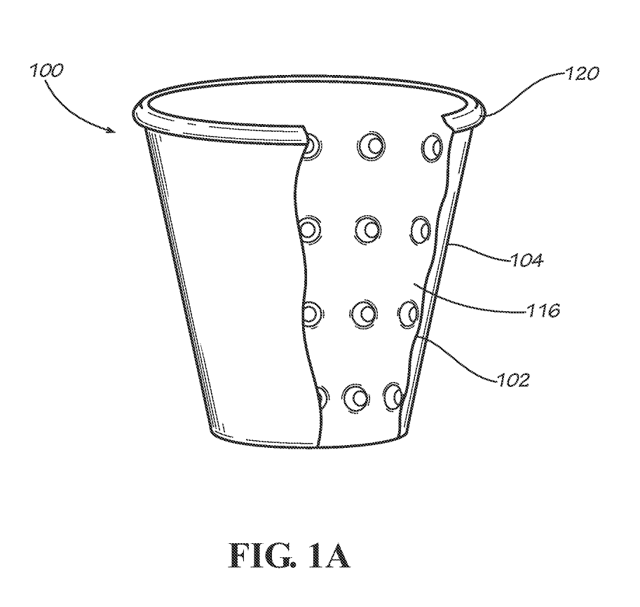

Referring now to FIGS. 1 and 1A, there is shown an air pocket insulated double-walled disposable plastic container 100. In one embodiment of the invention, the container 100 is preferably a cup. The container 100 includes an inner sheet 102 and an outer sheet 104. The inner sheet 102 is formed having inwardly protruding indentations 116 that create a plurality of air pockets 106 when the inner sheet 102 is attached to an inner surface 114 of the outer sheet 104 in a manner whereby the inwardly protruding indentations 116 contact the inner surface 114 of the outer sheet 104. The air pockets 106 are preferably uniformly distributed over the surface of the inner sheet. The air pockets 106 act as insulating layer. The inner sheet 102 and outer sheet 104 may be formed in any suitable shape that includes an opening at the top 112, an interior space 110 for containing food or beverages, and a base 108 enclosing the bottom.

The inner sheet 102 and outer sheet 104 may be joined or connected by any suitable techniques. A person skilled in the art would appreciate that various chemical or mechanical techniques may be used to join the inner sheet 102 and outer sheet 104 such as, without limitation, welding, ultrasonic welding, adhesive sealants, rim rolling or snap fitting sealing engagement. In a preferred, overhang rims of the inner sheet 102 and outer sheet 104 are rolled together by a conventional rim rolling process to form a curled overturned rim 120. Such double curling enhances the rigidity of the container 100.

The inner sheet 102, the outer sheet 104 may be formed of any suitable plastic. Preferred plastics include polypropylene (PP), polyethylene terephthalate (PET), polylactic acid (PLA), polystyrene (PS) or combinations thereof. It is also preferred that the plastic be food grade plastic.

In accordance with an embodiment of the invention, the outer sheet 104 is preferably of from about 0.005 to 0.030 inches in thickness and more preferably of from about 0.010 to 0.020 inches in thickness; and the inner sheet 102 is preferably of from about of 0.001 to 0.012 inches in thickness, and more preferably from about 0.005 to 0.010. The thickness between an inner surface 106′ surface of the air pockets 106 and the inner section 114 of the outer sheet 104 is preferably of from about 0.002 to about 0.006 inches, more preferably, from about 0.100 to 0.200 inches and even more preferably, from about 0.130 to 0.150 inches.

In one embodiment of the invention, the container 100 is transparent. Preferably, at least the inner sheet 102 and the outer sheet 104 are transparent. The inner sheet 102 and the outer sheet 104 may be formed from any suitable food grade plastics having transparent properties and a transparency value of 80 to 100%.

In another embodiment of the invention, the container 100 is translucent. Preferably at least the inner sheet 102 and outer sheet 104 are translucent. The inner sheet 102 and the outer sheet 104 may be formed from any suitable food grade plastics having translucent properties.

The container 100 may be of any suitable size or shape. The container 100 may be the size or shape of commonly used take-out containers to store food or beverage. Without limitation, the container may be a box-type container or have a length larger than the height. The container is preferably also suitable for use in a microwave or freezer.

In an embodiment, wherein the container 100 is a cup, the cup may be of any suitable size. For example, the cup can be made in sizes generally used in restaurants and coffee shops, including but not limited to 12, 16, 20, 21, 22, 32 and 44 oz cups.

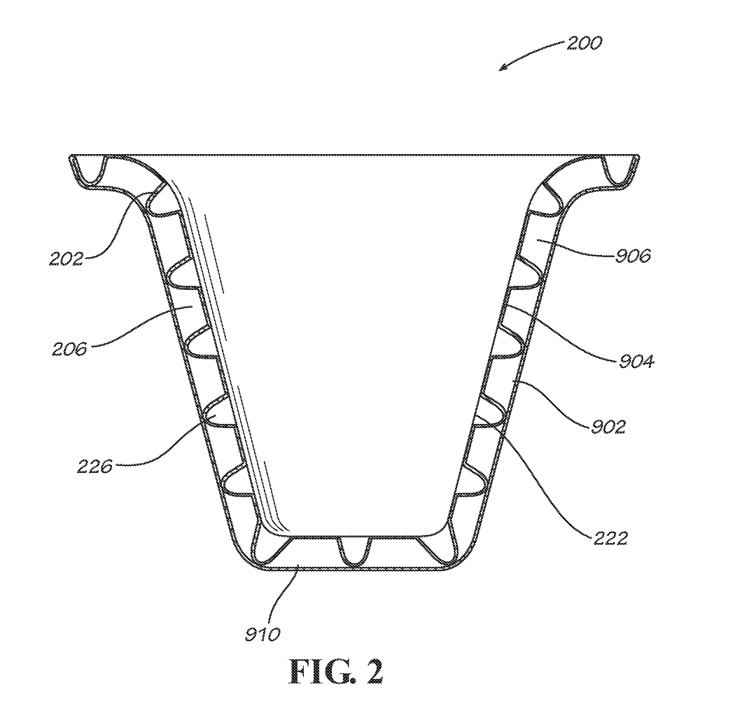

In another embodiment of the invention shown in FIG. 2 a cover sheet 222 may be formed over the inner sheet 202 to contact the outwardly protruding air pockets 206, thereby creating additional air pockets 226. The cover sheet 222 preferably has a smooth surface. The cover sheet 222 may be formed of any suitable material. In a preferred embodiment the cover sheet 222 is formed from a polymer based material, and even more preferably is a laminate surface. The cover sheet 222 may also be transparent or translucent, and in a preferred embodiment is transparent. The cover sheet creates a smooth interior lining for the container. The cover sheet 222 also facilitates container to container nesting and de-nesting during storage and on store shelves.

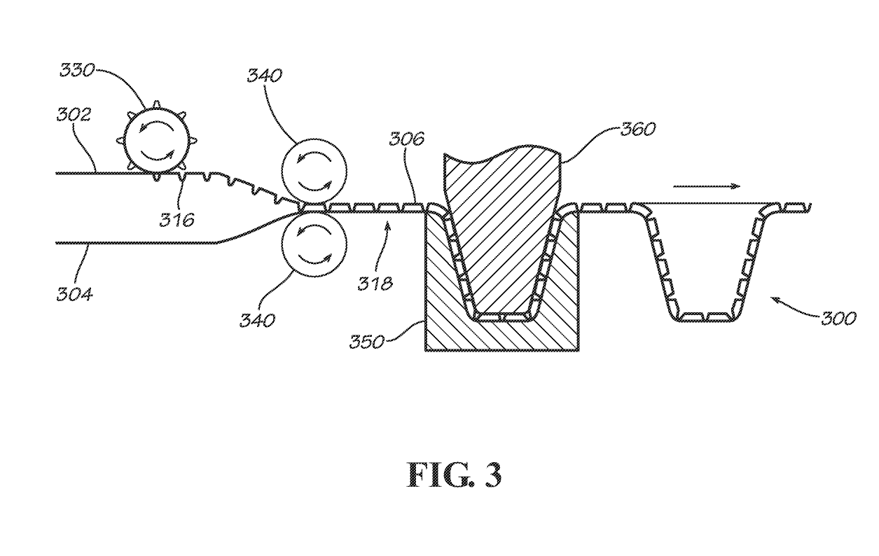

An air pocket insulated double-walled disposable plastic container in accordance with the invention may be formed by any suitable means. The outer sheet may be injection molded or thermoformed to the preferred thickness range. In an exemplary process of making the container of the invention shown in FIG. 3. The process of making the container includes, without any limitation, the steps of forming a first sheet 302 and a second sheet 304 from a polymeric material. Indentations or inwardly extending protrusions 316 are formed in the first sheet 302 by any suitable means to form an indented pattern. The indented pattern may be a series of notches or dents on one side of sheet which leads to a raised appearance on the other side. The second sheet 304 is preferably a smooth sheet having no indentations. The first sheet 302 and the second sheet 304 are then joined by contacting the inwardly protruding indentations 316 of the first sheet 302 to a surface of the second sheet 304, using any suitable joining mechanism. In a preferred embodiment, rollers 340 are used to attach the first sheet 201 and the second sheet 304. In another embodiment, the two sheets may be joined together using a fusing process. In yet another embodiment of the invention, the two sheets are bound together using a chemical mechanism, such as an adhesive or epoxy to create a double-walled sheet 318. Air pockets 306 are created between the inwardly extending protrusions. The air pockets 306 form insulation and act as a barrier useful for reducing heat transfer and keeping the contents of the container hot or cold.

The double-walled sheet 318 may then be used in a molding process to form a container 300. Any suitable molding processes may be used to form the container 300, including without limitation, thermoforming, vacuum forming, compression forming, transfer forming or combinations thereof. In an embodiment of the invention, the double-walled sheet 318 is molded using a cup-mold 350 and cup mandrel 360 by passing and pressing the double-walled sheet 318 between the cup-mold 350 and cup mandrel 360. Preferably the double-walled sheet has an overall thickness of from about 0.030 to about 0.300, and even more preferable from about 0.0115 to 0.230. The molding results in the formation of the container 300.

It should be apparent that the foregoing relates only to the preferred embodiments of the present application and that numerous changes and modifications may be made herein by one of ordinary skill in the art without departing from the general sprit and scope of the invention as defined by the following claims and equivalents thereof.

What is claimed:

1. A thermally insulated disposable plastic container, comprising:
i. a first plastic sheet having a thickness of about 0.005 to about 0.030 inches said first plastic sheet having inwardly protruding indentations formed therein and further comprising an inner surface and an outer surface, whereby said inner surface is configured inside of said container;
ii. a second plastic sheet having a thickness of about 0.001 to about 0.012 inches further comprising an inner wall and an outer wall whereby said outer wall forms an outside of said container and said inner wall is connected to said inwardly protruding indentations of said outer surface of said first sheet in a manner configured to form a plurality of uniformly distributed air pockets betweens said first plastic sheet and said second plastic sheet, said air pockets having a thickness of about 0.002 to about 0.006 inches for providing thermal insulation for any material disposed within said container; and
iii. a plastic base closure connected to a bottom portion of said first plastic sheet and said second plastic sheet.

2. The container of claim 1, wherein at least said first plastic sheet or said second plastic sheet is transparent, translucent or opaque.

3. The container of claim 1, wherein said air pockets substantially surround said container.

4. The container of claim 1, further comprising a rim formed from joining said first plastic sheet and said second plastic sheet at an upper lip section, whereby said rim is curved or curled.

5. The container of claim 1, wherein said first plastic sheet and said second plastic sheet are formed from polypropylene, polyethylene terephthalate, polylactic acid, polystyrene or combinations thereof.

6. The container of claim 1, further comprising a sheet formed over said inner surface of said first plastic sheet.

7. A double-walled disposable cup comprising an outer cup and an inner cup formed of a polymer based material and being separated by a mass of protrusions formed on a substantial portion of an inner surface of the inner cup, whereby said protrusions contact an inner surface of said outer cup to form a layer comprising a mass of pockets of air between said inner cup and said outer cup, wherein said inner cup has a wall thickness of from about 0.001 to about 0.012 inches and said outer cup has a wall thickness of about 0.005 to about 0.030 inches.

8. The double-walled cup of claim 7, wherein both said inner cup and said outer cup are transparent or translucent.

9. The double-walled cup of claim 7, wherein said polymer based material comprises polypropylene, polyethylene terephthalate, polylactic acid, polystyrene or a combination thereof.

10. The double-walled cup of claim 7, further comprising a rim formed from at least said inner cup or said outer cup.

11. The double-walled cup of claim 10, wherein the inner cup and outer cup both have an overhang section that are rolled together to form a unitary curled rim for said cup.

12. The double-walled cup of claim 11, further comprising at least one sheet of polymeric material formed over said inner cup.

13. The double-walled cup of claim 12, wherein said at least one sheet of polymeric material is a laminate.

14. The double-walled cup of claim 7, wherein said layer of pockets of air has a thickness of about 0.025 to about 0.250 inches.

15. The double-walled cup of claim 14, wherein said inner cup has a wall thickness of from about 0.005 to about 0.010 inches, said outer cup has a wall thickness of about 0.010 to about 0.020 inches, and wherein said layer of pockets of air has a thickness of about 0.013 to about 0.150 inches.

16. A method of forming an air pocket insulated disposable plastic container, comprising the steps of:
forming a first sheet having a wall thickness of about 0.005 to about 0.030 inches from a polymer based material;
forming an second sheet having a wall thickness of from about 0.001 to about 0.012 inches from a polymer based material;
forming a plurality of uniformly spaced indentations in said second sheet;
forming the second sheet over the first sheet and connecting said indentations to said first sheet to form a plurality of uniformly spaced air pockets between said indentations whereby the first sheet and second sheet form a double-walled sheet; and
molding said double-walled sheet to form a container.

17. The method of claim 16, wherein said step of molding said container comprises, thermoforming, vacuum forming, compression forming, transfer forming or a combination thereof.

18. The method of claim 16, wherein said step of molding is performed using a mold and mandrel to press said double-walled sheet into a container shape.

19. The method of claim 18, wherein said step of connecting said indentations to said first sheet comprises fusing, pressing, ultrasonic welding or a chemical adhesion process.

20. The method of claim 18, wherein said step of forming a plurality of uniformly spaced indentations comprises using at least one protrusion forming mandrel.

21. The method of claim 16, further comprising forming a mass of said plurality of uniformly spaced air pockets and whereby said double-walled sheet has a thickness about 0.030 to 0.300.
